(19) United States
(12) Patent Application Publication
(10) Pub. No.: US 2025/0116406 A1
(43) Pub. Date: Apr. 10, 2025

(54) TIMED COMBUSTION DEVICE

(71) Applicant: Snowie LLC, Salt Lake City, UT (US)

(72) Inventor: Carl A. Rupp, Salt Lake City, UT (US)

(73) Assignee: Snowie LLC, Salt Lake City, UT (US)

(21) Appl. No.: 18/908,324

(22) Filed: Oct. 7, 2024

Related U.S. Application Data
(60) Provisional application No. 63/588,637, filed on Oct. 6, 2023.

(51) Int. Cl. F24C 3/00; B60N 3/10; B60N 3/16; B60P 3/025; F23N 5/20; F24C 15/06

(52) U.S. Cl. CPC F24C 3/006; F23N 5/203; F24C 15/06; B60N 3/10; B60N 3/16; B60P 3/0257; F23N 2225/14; F23N 2227/28

(57) ABSTRACT

Actuation of timed combustion events that may be emitted from an edifice. A system includes a mobile edifice, a controller, a fuel source comprising a fuel, and a combustion device mounted to the mobile edifice. The combustion device includes a heat source in electronic communication with the controller, and a gate in electronic communication with the controller. The system is such that the gate opens to permit fuel to flow from the fuel source to toward the heat source, and such that the controller actuates the heat source and the gate to trigger a combustion event.

### CROSS-REFERENCE TO RELATED APPLICATIONS

This application claims the benefit of U.S. Provisional Patent Application No. 63/588,637, filed Oct. 6, 2023, titled “TIMED COMBUSTION DEVICE,” which is incorporated herein by reference in its entirety, including but not limited to those portions that specifically appear hereinafter, the incorporation by reference being made with the following exception: In the event that any portion of the above-referenced patent application is inconsistent with this application, this application supersedes the above-referenced patent application.

### TECHNICAL FIELD

The present disclosure relates generally to combustion devices and more specifically to mountable combustion devices not requiring an always-on heat source. The present disclosure also relates to mobile edifices and the use of combustion devices to draw attention to a product or service that may be sold at such a mobile edifice.

### BACKGROUND

Combustion devices are designed to facilitate and control the process of combustion. Combustion is a chemical reaction between a fuel and an oxidizing agent (usually oxygen) that releases energy in the form of heat and light. Combustion devices are used in many contexts, such as internal combustion engines, gas turbines, boilers, furnaces, stoves, ovens, incinerators, rocket engines, and heaters. Combustion devices typically combust a mixture of fuel (usually gasoline, diesel, or natural gas) and air within a confined space, such as a cylinder. The combustion process can generate gas pressure that can be used to drive pistons or motors for motorized vehicles, power generation, heat generation, and many other applications.

Accordingly, modern combustion devices often incorporate sophisticated control systems to optimize combustion efficiency, minimize emissions, and ensure safe operation. Combustion devices may employ sensors for combustion analysis, which can involve monitoring parameters like oxygen levels, temperature, and emissions to achieve efficient and clean combustion. As technology advances, there is a growing emphasis on making combustion processes more efficient, cleaner, and environmentally friendly. Combustion devices utilizing gas flow, particularly for heating appliances, frequently require a pilot light that is always on in order start a flame. Typically, such devices need a continuously running heat source to serve as an ignition point for flowing gas. As an example, in a home, pilot lights can consume about 600 BTU's of gas/hour, or roughly 14,400/BTU's a day.

Like ice cream trucks with music, or stores having employees spinning signs or waving inflatable dummies, some commercial operators may wish to use devices to draw attention of potential customers. However, combustion devices have not been utilized due to safety and other concerns.

Accordingly, there is a need for a type of combustion device one can use to draw attention to promote a product or service while being operated safely, efficiently, and in an environmentally friendly manner.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic illustration of a side view of a combustion device;

FIG. 2 is a schematic illustration of a system including a combustion device and a fuel source;

FIG. 3A is a schematic illustration of a system including a combustion device, fuel source, and controller, wherein the controller has actuated heating of a heat source;

FIG. 3B is a schematic illustration of a system including a combustion device, fuel source, and controller, wherein the controller has actuated heating of a heat source and has opened a gate to permit fuel flow;

FIG. 3C is a schematic illustration of a system including a combustion device, fuel source, and controller, wherein the controller has enabled fuel to flow to generate a fuel accumulation near a heat source;

FIG. 3D is a schematic illustration of a system including a combustion device, fuel source, and controller, wherein the controller has enabled sufficient fuel to flow near a heated heat source to trigger a combustion event;

FIG. 4 is a schematic illustration of a system including numerous combustion devices;

FIG. 5 is a schematic illustration of a perspective view of a system including a combustion device mounted to a mobile edifice;

FIG. 6 is a schematic illustration of a perspective view of a system including a combustion device mounted to a mobile edifice;

FIG. 7 is a schematic illustration of a perspective view of a system including a combustion device mounted to a mobile edifice;

FIG. 8 is a schematic illustration of a perspective view of a system including a combustion device mounted to a mobile edifice;

FIG. 9 is a schematic diagram of a series arrangement of a plurality of combustion devices in fluid communication with a fuel source;

FIG. 10 is a schematic diagram of a parallel arrangement of a plurality of combustion devices in fluid communication with a fuel source;

FIGS. 11A and 11B are schematic flow chart diagrams of a method for remotely actuating a heat source and a gate of a combustion device to trigger a combustion event having a desired flame size; and

FIG. 12 is a schematic flow chart diagram of a method for triggering a combustion event.

### DETAILED DESCRIPTION

Some commercial applications for combustion devices include those intended for creating a spectacle. Like ice cream trucks with music, stores having employees spinning signs, or stores with waving inflatable dummies, some commercial operators may wish to use fire, like pyrotechnics or combustion devices, to draw the attention of potential customers. Big flames can make for a big spectacle, which can be useful in drawing the attention of crowds. However, use of fire can raise safety and cost concerns.

Accordingly, there is a need for a type of combustion device one can use to draw attention to promote a product or service while being operated safely, efficiently, and in an environmentally friendly manner.

Described herein are systems, methods, and devices for electronically triggering a combustion event. The systems, methods, and devices described herein are designed to be mounted to a mobile edifice like a truck or van.

Described herein is an electronically controller combustion system. The system includes a controller, heat source, plunger mechanism, and fuel source. The controller coordinates actuation of the plunger mechanism, heat source, and release of fuel to create a burst of flame. The burst of flame may be used for a variety of purposes and may specifically be used to attracted attention of people in vicinity of the system. The controller is utilized to optimize the size and duration of the burst of flame. The controller may further be used to actuate multiple combustion devices to create a sequence of pattern of bursts of flame.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the methods, systems, and devices for triggering a combustion event are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

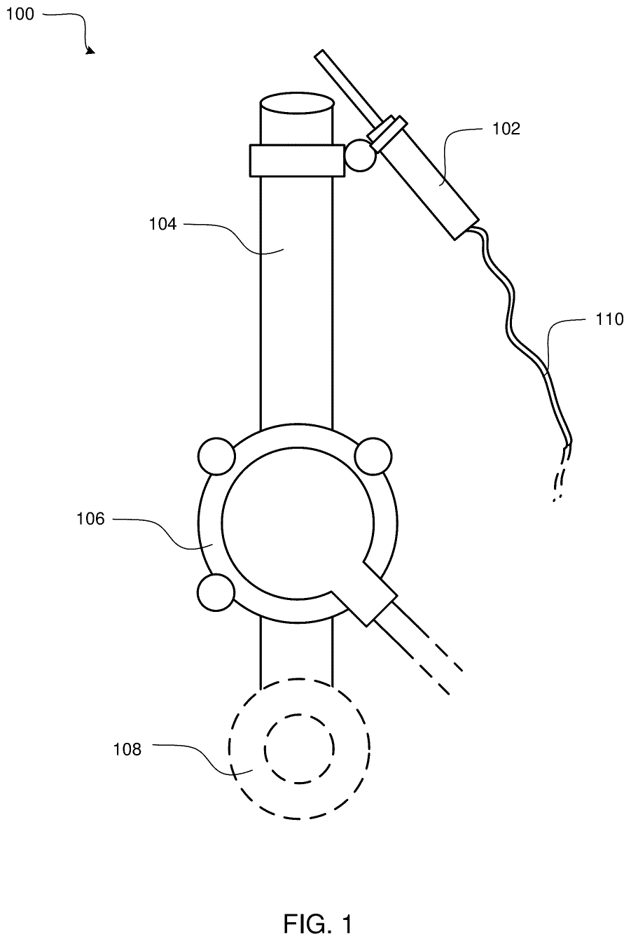

Referring now to the figures, FIG. 1 is a schematic illustration of a straight-on side view of a combustion device 100 for triggering a combustion event. The combustion device 100 may be utilized with a controller to electronically trigger a flame burst or steady flame combustion event. In some use-cases, the combustion device 100 may be utilized to trigger a flame that emits during a performance. In other use-cases, the combustion device 100 may be utilized to trigger a flame that is emitted from a mobile or stationary edifice to capture attention of nearby persons. It should be appreciated that the combustion device 100 may be utilized in various scenarios without departing from the scope of the disclosure.

The combustion device 100 includes a heat source 102, distal fuel pipe 104, gate 106, and proximal fuel pipe 108. The combustion device 100 components work together to enable electronic triggering of a flame burst or steady flame combustion event. The combustion device 100 components further enable electronic control of the size and duration of the flame burst or steady flame combustion event.

The heat source 102 may include a spark or igniter. In some cases, the heat source 102 includes a pilot light or equivalent device, but the combustion device 100 is designed to function without a constantly lit heat source. When the heat source 102 does not include a constantly lit heat source like a pilot light, then a user may freely turn the heat source 102 on and off. This further enables the user to utilize a mobile fuel source such as a propane tank that may be turned off during transport and periods without use.

The combustion device 100 includes fuel piping for enabling a liquid or gas fuel to travel to a distal end and be lit by the heat source 102. The fuel piping may specifically include the distal fuel pipe 104, which is located distal from the fuel source. The fuel piping may additionally include a proximal fuel pipe 108 that is located proximal to the fuel source relative to the distal fuel pipe 104. In FIG. 1, the proximal fuel pipe 108 is oriented into our out of the page, such that the proximal fuel pipe 108 is oriented substantially perpendicular to the distal fuel pipe 104. The combustion device 100 may include a T-joint for joining the distal fuel pipe 104 and the proximal fuel pipe 108.

The combustion device 100 includes a gate 106, which may include a valve, plunger, shutter, or other gate-type mechanism. The gate 106 is in electronic communication with a controller (not shown in FIG. 1). The controller provides power to the gate 106 and actuates opening and closing of the gate 106. When the gate 106 is open, fuel is permitted to flow from the proximal fuel pipe 108, through the gate 106, and into the distal fuel pipe 104. If the heat source 102 is on and sufficiently hot, then the fuel may ignite when passing by the heat source 102. When the gate 106 is closed, fuel flow is stopped such that fuel does not flow past the heat source 102 and combust.

The heat source 102 may be in direct electrical communication with the controller (not shown in FIG. 1) by way of a heat source cable 110. The heat source cable 110 may enable the transmittance of electricity and/or electronic instructions from the controller to the heat source 102. The heat source cable 110 enables the controller to cause the heat source 102 to quickly and reliably turn on and off.

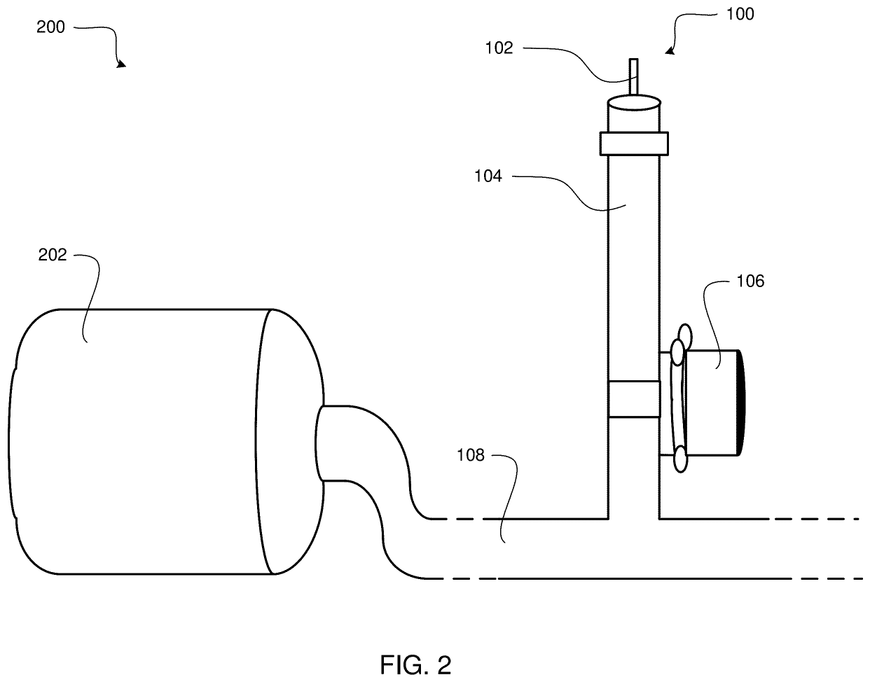

FIG. 2 is a schematic illustration of a straight-on side view of a system 200 for triggering a combustion event. The system 200 includes a fuel source 202 and additionally includes the combustion device 100 described in connection with FIG. 1.

The fuel source 202 may include a vessel that stores a liquid or gas fuel. The fuel may specifically be a combustible fuel like propane. The fuel source 202 may include a conventional tank as shown in FIG. 2 or may include another suitable means for storing a combustible fuel. The fuel itself may include propane or another combustible fuel depending on the implementation.

The fuel source 202 is in fluid communication with the combustion device 100. In some implementations and as shown in FIG. 2, the fuel source 202 is in direct fluid communication with the combustion device by way of the proximal fuel pipe 108. In other implementations, the system 200 includes additional pipes, hoses, or tubes connecting the fuel source 202 to the proximal fuel pipe 108.

The system 200 may be configured such that fuel is permitted to freely from the fuel source 202 through the proximal fuel pipe 108. The system 200 may be configured such that flow of the fuel from the fuel source 202 to the proximal fuel pipe 202 is controlled by a controller that activates or deactivates fuel flow based on user need.

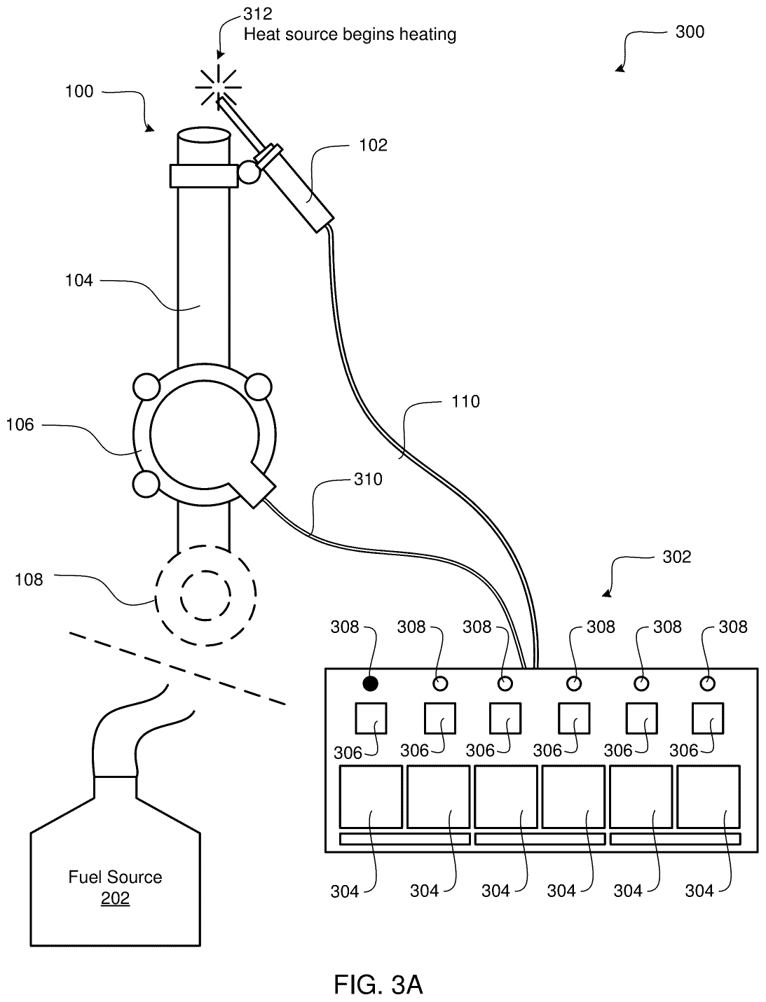

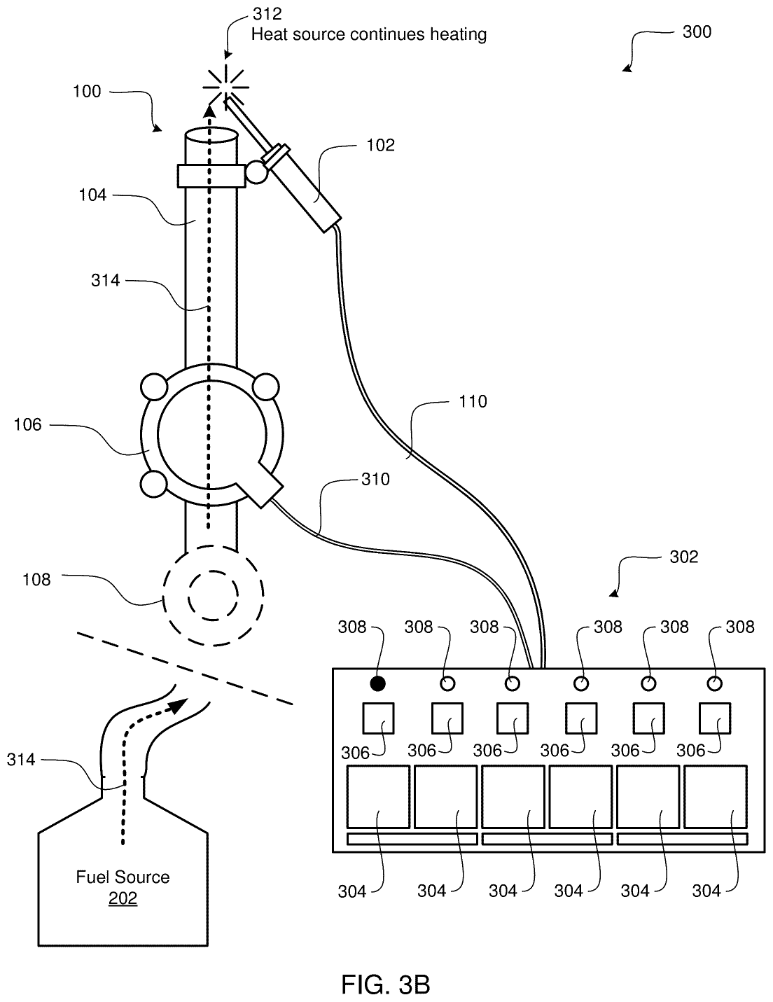

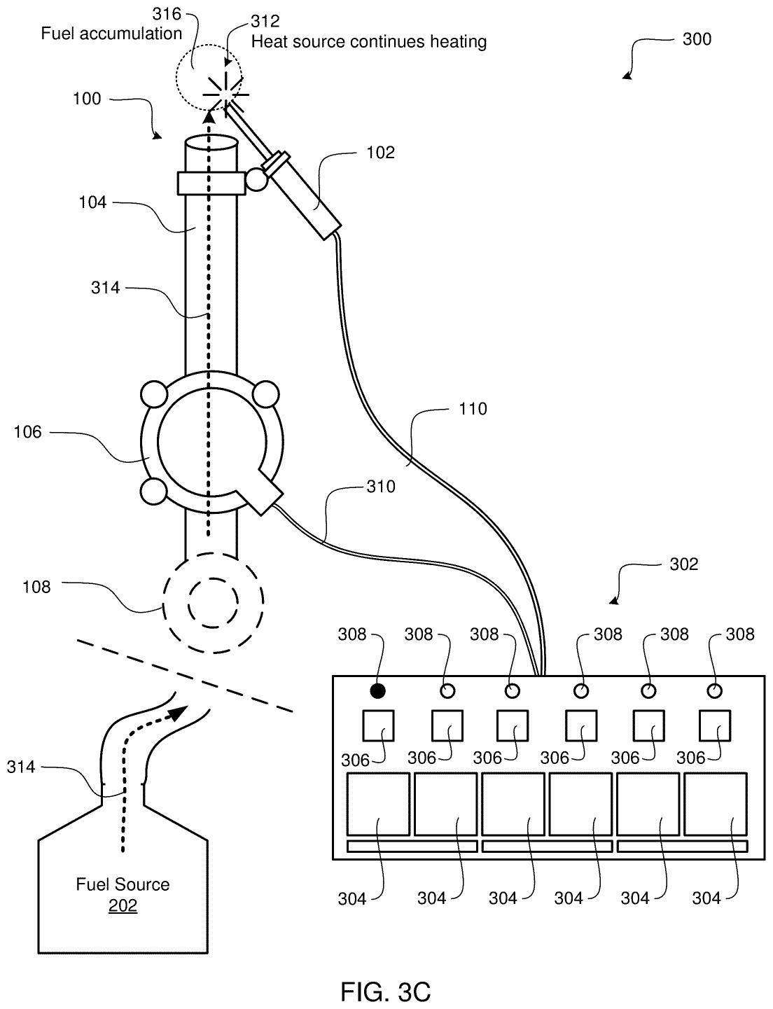

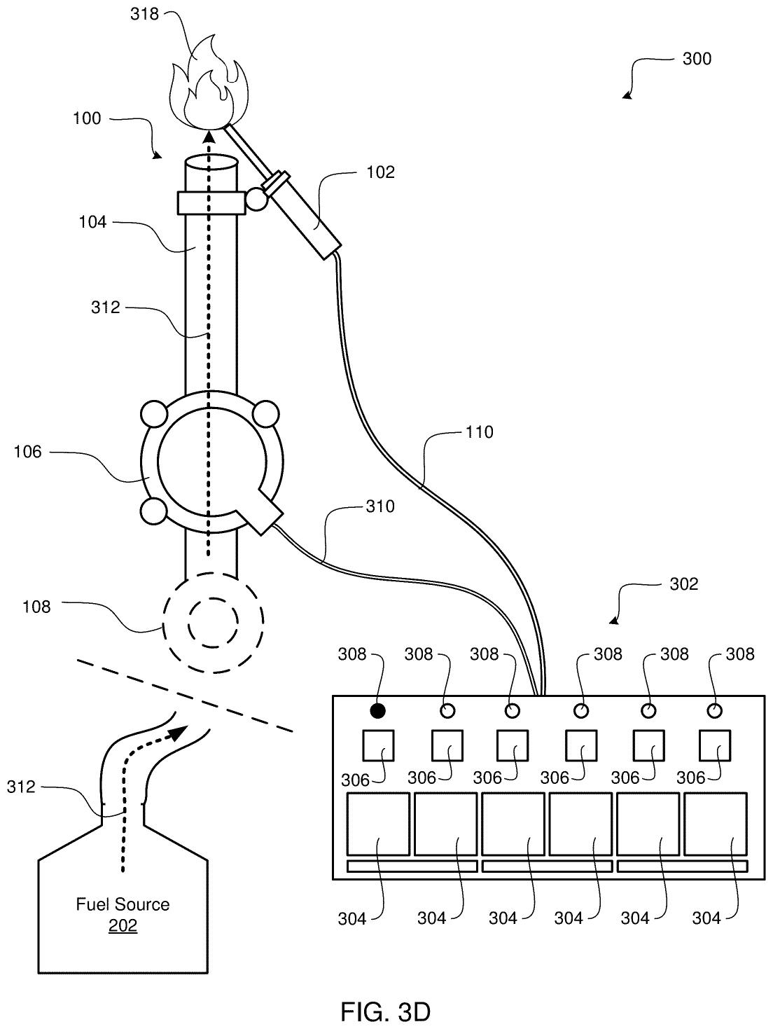

FIGS. 3A-3D are schematic illustrations of components of a system 300 for triggering a combustion event. FIG. 3A illustrates wherein a heat source 102 of the combustion device 100 is turned on, but the flow from the fuel source 202 is closed. FIG. 3B illustrates wherein the heat source 102 continues to heat and fuel is allowed to flow from the fuel source 202 to the distal end of the combustion device 100. FIG. 3C illustrates wherein sufficient fuel flows to the distal end of the combustion device 100 to create a fuel accumulation. FIG. 3D illustrates wherein the fuel accumulation ignites due to the heat source 102 being sufficiently hot.

The system 300 includes a combustion device 100 and additionally includes a controller 302 for remotely and electronically actuating components of the combustion device 100. The controller 302 may be in direct or indirect electronic communication with the heat source 102 and the gate 106. In some cases, the heat source cable 110 provides direct electronic communication and power transmittance between the heat source 102 and the controller 302. The system 300 may additionally includes a gate cable 310 that provides direct electronic communication and power transmittance between the gate 106 and the controller 302. In alternative implementations, one or more of the gate 106 or the heat source 102 may receive power from a source other than the controller 302. In these implementations, the gate 106 and/or the heat source 102 could be wirelessly controlled by the controller 302.

The controller 302 may include a plurality of slots for controlling a plurality of devices, such as gates 106 and heat sources 102. In the example illustrated in FIGS. 3A-3D, the controller 302 includes six separate slots for remotely actuating six separate devices. The controller 302 may include any number of slots as deemed necessary based on the desired use-case and implementation. Each of the slots may control a device such as a gate 106 or a heat source 102. Thus, the exemplary controller 302 illustrated in FIGS. 3A-3D could remotely control three separate combustion devices 100, with each of the three separate combustion devices 100 including one gate 106 and one heat source 102. Each slot in the controller 302 includes a circuit 304, switch 306, and feedback display 308. The circuit 304 may include a microcontroller for processing data output by a device, tracking the time, and determining whether a device should be actuated. The switch 306 may include a button, toggle, switch, touchscreen display, or any suitable means for manually actuating a slot. The feedback display 308 may include a light, screen, or other indicator for indicating that the slot has actuated a device.

The controller 302 actuates the heat source 102 by providing power and/or instructions to the heat source 102. The heat source 102 begins to heat in response to receiving power and/or instructions from the controller 302 (see 312 at FIG. 3A). The heat source 102 may include a thermometer for measuring the current temperature of the heat source 102, and the heat source 102 may report its current temperature back to the controller 302. In this case, the heat source cable 110 may enable bidirectional communication between the heat source 102 and the controller 302. The heat source cable 110 may comprise a temperature sensor located at its distal end to enable the controller 302 to measure the current heat of the heat source 102. The controller 302 may be programmed to cause the gate 106 to open in response to determining the heat source 102 is sufficiently hot.

FIG. 3B illustrates wherein the controller 302 electronically actuates the gate 106 and thereby permits fuel to flow (see 314) from the fuel source 202 to the distal end of the distal fuel pipe 104. FIG. 3C illustrates wherein fuel continues to flow from the fuel source 202 and forms a fuel accumulation 316 near the heat source 102. When the controller 302 actuates the gate 106, a mechanism within the gate 106 opens a passage and enables fuel to flow from the proximal fuel pipe 108, through the gate 106, and into the distal fuel pipe 104 (see fuel flow 314). The amount of time the gate 106 is open may vary according to the use-case and desired length of the flame burst or steady flame combustion event.

FIG. 3D illustrates wherein the heat source 102 is sufficiently hot and the fuel accumulation 316 is sufficiently large to cause a flame combustion event 318. The size of the combustion event 318 will be determined based on the size of the fuel accumulation 316, and thus depends on how long the gate 106 is open while the heat source 102 continues to reach the required temperature to trigger combustion of the fuel. The controller 302 is programmed to optimize the duration of time the gate 106 is open based on the expected time required for the heat source 102 to reach a threshold temperature to trigger the combustion of the fuel. If a small combustion event 318 is desired, then the controller 302 may open the gate 106 after the heat source 102 has already reached the threshold temperature. If a larger combustion event 318 is desired, then the controller 302 may open the gate 106 prior to heating the heat source 102 or while the heat source 102 is still heating. The duration of the combustion event 318 will be determined based on whether the gate 106 remains open after the combustion event 318 ignites.

The controller 302 may cause the gate 106 to open for as little as 0.001 seconds. The controller 302 may cause the gate 106 to remain open for as long as desired by a user. If the user desires a steady state combustion event, then the user may indicate the gate 106 should remain open. If the user desires a flame burst combustion event, then the user may indicate the gate 106 should open briefly and then close again. The variable timing of the gate 106 opening allows a user to control the amount of fuel that flows past the heat source 102.

When fuel interacts with the heat source 102, the fuel may interact with ambient oxygen to ignite and create a first flame of a combustion event 318. Depending on the implementation, a minimal amount of time may need to pass in order to create enough gas pressure and to allow the heat source 102 to get hot enough. For example, some time from several seconds to several minutes may be necessary before a combustion event 318 is triggered. Depending on the size of the combustion event 318 desired, the heat source 102 may need time to reach somewhere between about 250° C. to about 380° C., or between about 260° C. to about 365° C., or between about 270° C. to about 360° C., or between about 275° C. to about 355° C., or between about 280° C. to about 350° C., or between about 285° C. to about 345° C., or between about 290° C. to about 340° C., or between about 290° C. to about 335° C., or between about 295° C. to about 330° C., or between about 300° C. to about 325° C., or about 315° C., depending on the user's implementation.

The distal fuel pipe 104 may be longer, have a greater diameter, or otherwise vary in size to allow a greater amount of fuel to enter the distal fuel pipe 104. A variable amount of fuel may allow for a variable combustion event 318 that could result in a larger or smaller flame that lasts for a larger or smaller duration. The controller 302 may control the gate 106 to “open” for a larger or shorter amount of time to facilitate the variable gas flow into distal fuel pipe 104. The combination of the gate 106 operating and the heat source 102 igniting may produce a “ch-chunk” sort of sound. In addition, the controller 302 may cause the gate 106 to open not only once, but multiple times to stagger the amount of fuel that enters distal fuel pipe 104. As a result, a staggered, patterned combustion event 318 is possible and the duration or intensity of the combustion event 318 may vary according to a user's needs.

The controller 302 may be manually instructed to instigate a combustion event 318 in response to user engaging with a button, switch, or other means on the controller 302. The controller 302 may be programmed to trigger the combustion event 318 according to a programmed time interval. The controller 302 may be programmed to trigger a series of gate 106 openings to trigger a series of combustion events 318. The controller 302 may include both manual and automatic activation to suit a user's needs.

The system 300 may trigger a sequence of combustion events 318, and each combustion event 318 may vary in size and/or duration. To trigger a subsequent combustion event 318, the controller 302 may cause the gate 106 to open for a longer period of time than the previous event in order to trigger a bigger flame. A timing of the opening of the gate 106 may be controlled to influence the size of the subsequent combustion event 318. A subsequent combustion event 318 may be produced by the same combustion device 100 after sufficient time has passed after a prior combustion event 318, to allow sufficient fuel buildup and allow the heat source 102 to reach a sufficient temperature.

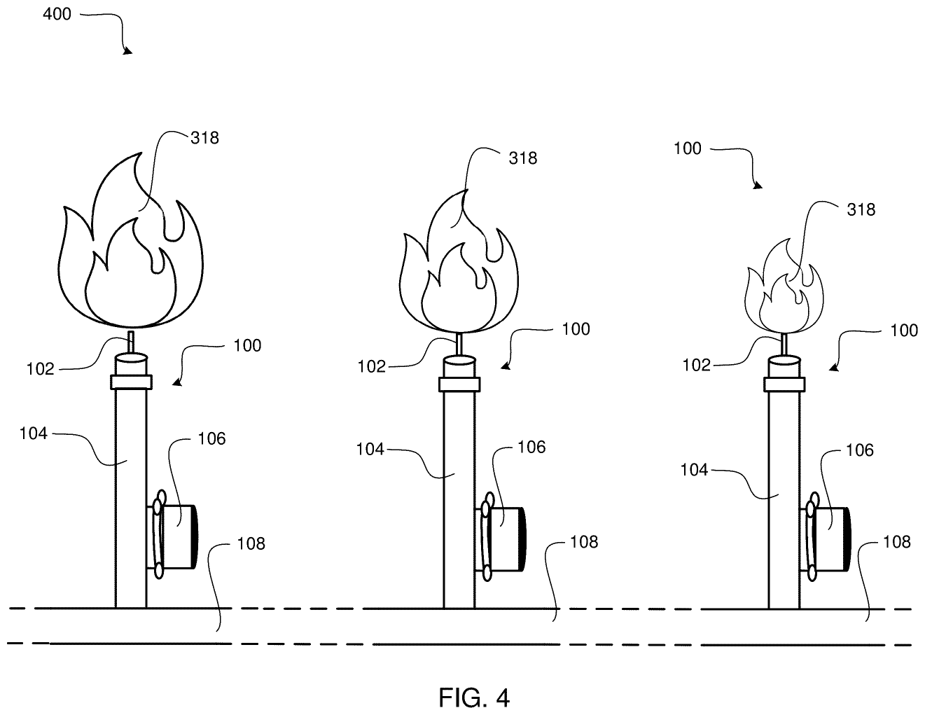

FIG. 4 is a schematic illustration of a system 400 that includes numerous combustion devices 100. The system 400 is constructed such that combustion devices 100 are arranged in series. However, the system 400 may be designed such that the combustion devices 100 are arranged in parallel.

In implementations wherein the heat source 102 does not include an open flame such as a pilot light, the combustion devices described herein may undergo a reset period after a combustion event 318. The reset period requires that some time must pass before the same combustion device 100 is capable of triggering another combustion event 318. The system 400 enables a user to trigger multiple combustion events 318 in a short sequence by using multiple combustion devices 100.

Each of the combustion devices 100 may be joined together by a proximal fuel pipe 108. The proximal fuel pipe 108 may facilitate gas flow from a fuel source (see 202) to each combustion device 100. A controller (see 302) may be in electrical communication with each of the heat sources 102 and gates 106 of each combustion device 100 and may independently control each heat source 102 and gate 106 of each combustion device 100. Each of the combustion devices 106 may additionally include a sensor that provides data to the controller (see 302) and enables the controller to determine whether the heat source 102 is sufficiently hot to allow fuel to pass through the fuel pipes. If the heat source 102 is not sufficiently hot, then the controller may ensure the gates 106 are closed to prevent fuel leakage. A controller may independently control the plurality of combustion devices 100 in order to create a sequence of combustion events 318 of varying sizes, durations, and timings. The sequence may begin with a smaller, first combustion event 318. Subsequently, additional combustion devices 100 can be activated to produce larger combustion events 318.

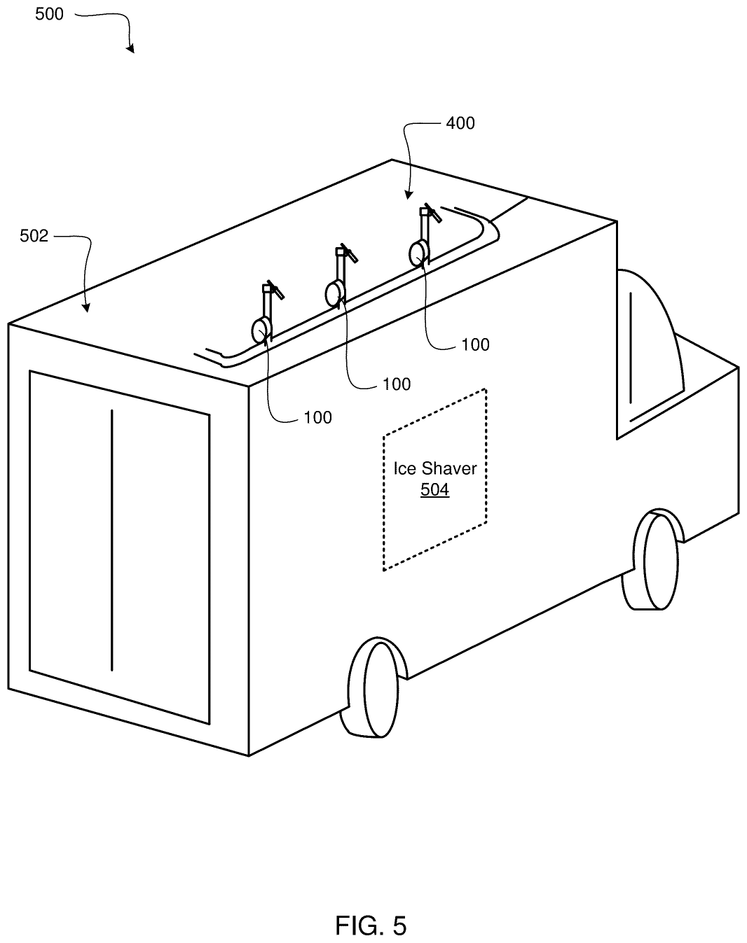

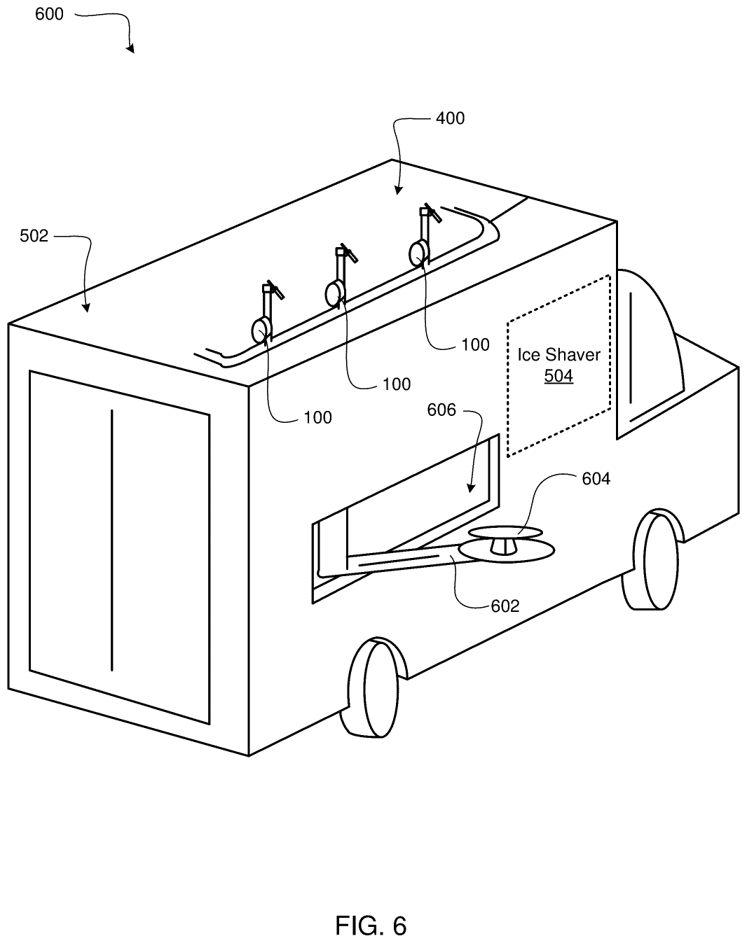

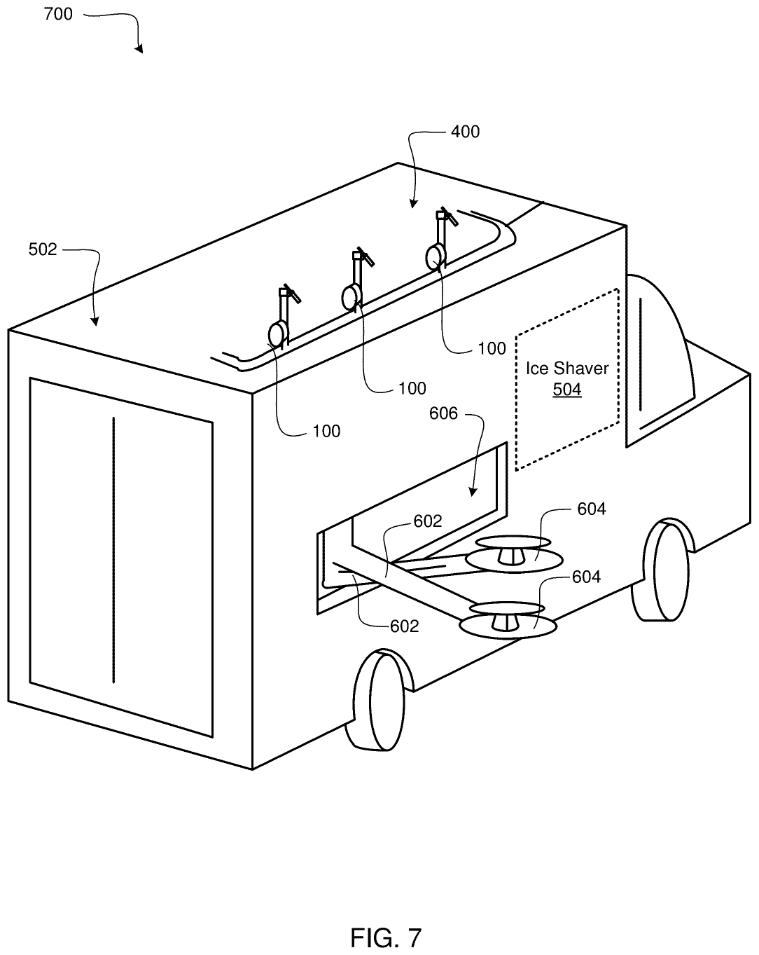

FIGS. 5-7 are schematic illustrations of perspective views of systems including a combustion device mounted to a mobile edifice. FIG. 5 is a schematic illustration of a perspective view of a system 500 including a combustion system 400 mounted to a mobile edifice 502. FIG. 6 is a schematic illustration of a perspective view of a system 600 including a combustion system 400 mounted to a mobile edifice 502, and additionally illustrates wherein a fluid dispenser may be mounted to the mobile edifice 502. FIG. 7 is a schematic illustration of a perspective view of a system 700 including a combustion system 400 mounted to a mobile edifice 502, and additionally illustrates wherein a fluid dispenser may be mounted to the mobile edifice 502.

The system 500 illustrated in FIG. 5 includes a plurality of combustion devices 100 mounted to a mobile edifice 502. The mobile edifice 502 may include a vehicle as shown in FIG. 5. The mobile edifice 502 may include a wheeled cart, kiosk, or stand. The mobile edifice 502 may alternatively be implemented as a stationary edifice such as a kiosk, building, fence, wall, or other structure.

In the example illustrated in FIG. 5, the mobile edifice 502 is equipped for preparing food-grade consumable products and is specifically equipped to prepare frozen confections such as shaved ice. In this example, the mobile edifice 502 comprises an ice shaver 504 mounted to and/or disposed within the mobile edifice 502. However, the mobile edifice 502 may be equipped to perform other functions, including other functions relating to preparing food-grade products. The mobile edifice 502 may include other devices such as grills, stovetops, refrigerators, and so forth.

The system 500 includes a combustion system 400 mounted to a roof of the mobile edifice 502. The combustion system 400 includes a plurality of combustion devices 100 and specifically includes three combustion devices 100. The system 500 may include any number of combustion devices 100 as deemed necessary or desired by a user. In the example illustrated in FIG. 5, the combustion devices 100 are mounted to a roof of the mobile edifice 502. However, in alternative implementations, the combustion devices 100 may be mounted to a vertical sidewall or other exterior surface of the mobile edifice 502.

FIG. 6 is a schematic illustration of a perspective view of a system 600 including a combustion device 100 mounted to a mobile edifice 502. The system 600 includes the components described in connection with FIG. 5, and additionally includes systems and devices for dispensing fluids from the mobile edifice 502. The system 600 may be particularly useful if the mobile edifice 502 is equipped with an ice shaver 504 for preparing frozen confections. The mobile edifice 502 may additionally equipped with dispensers for dispensing flavored syrups or other fluids for use in connection with a shaved ice confection.

The system 600 includes a fluid dispenser 604 and a mounting arm 602 that supports the fluid dispenser 604 and enables a user to pull the fluid dispenser 604 out for use, and then store the fluid dispenser 604 within a cavity 606 disposed within the mobile edifice 502. The fluid dispenser 604 may be mounted or otherwise attached to the mobile edifice 502 via the mounting arm 602. The mounting arm 602 may be joined to the mobile edifice 502 and may freely pivot about an axis in some implementations, while in other implementations, the mounting arm 602 may be fixed to the mobile edifice 502. The mounting arm 602 may be mounted to a sidewall of the mobile edifice 502, to a roof of the mobile edifice 502, to a front or rear of the mobile edifice 402, or anywhere suitable at some point on the mobile edifice 502. The sidewall may comprise a wall of the mobile edifice 502, a shelf, a stand, a door, or a similar construct suitable for mounting a mounting arm thereto, depending on the implementation.

The fluid dispenser 604 may be mounted to a distal end of the mounting arm 602 in some implementations, while in others one or more dispenser assemblies may be positioned at various positions along the length of the mounting arm 602. In some implementations, more than one arm 602 may be mounted to the mobile edifice 502. In such cases, these mounting arms may be mounted at roughly the same point together or each may be independently mounted to separate positions on a mobile edifice 502.

FIG. 7 is a schematic illustration of an implementation of a system 700 for dispensing fluids from a mobile edifice 502. The system 700 illustrated in FIG. 7 includes similar components to the systems 500, 600 first illustrated in FIGS. 5 and 6 but differs by including two independent mounting arms 602 and fluid dispensers 604 mounted to the mobile edifice 502 within the cavity 606.

In the system 700, each mounting arm 602 may be independently rotatable around an axis defined by the mounting point on the mobile edifice 502. In some implementations a user may choose to maintain independent mounting arms 602 at different temperatures depending on the user's needs. Depending on the implementation, a user may elect to have the same flavors or assorted flavors travel through each mounting arm 602 present to each mounting arm 602's respective fluid dispenser 604.

As a non-limiting example, a user may have first flavoring delivered through a first mounting arm and second flavoring delivered through a second mounting arm. In other implementations a user may have a first and second flavoring available through both the first mounting arm and the second mounting arm. In yet other implementations one mounting arm may be dedicated to its own non-flavoring fluid, such as water with which a user may receive a drink or wash their hands. In other implementations a user may have three or more mounting arms and may deliver individual, unique, combination, or any other configuration or organization of fluids through each mounting arm 602 to the fluid dispenser 604.

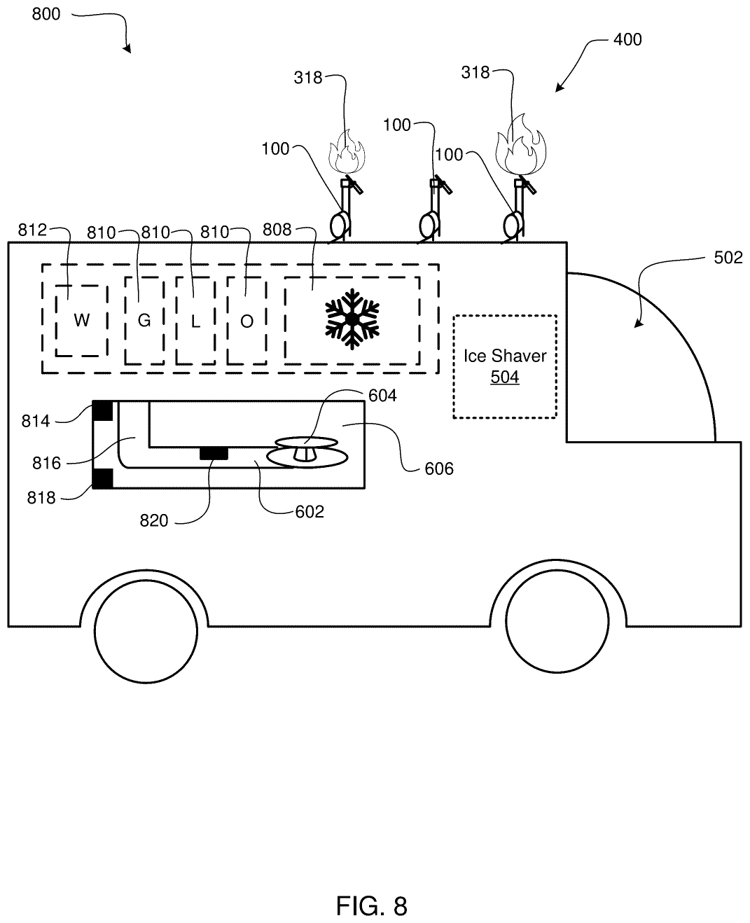

FIG. 8 is a schematic illustration of a side view of a system 800 for mounting combustion devices 100 and components for dispensing shaved ice confections to a mobile edifice 502. The system 800 includes a plurality of combustion devices 100 mounted to a roof of the mobile edifice 502. The system 800 additionally includes a fluid dispenser 604 mounted within a cavity 606 of the mobile edifice 502. The system 800 additionally includes further components for preparing and dispensing a shaved ice confection from the mobile edifice 502, including, for example, an ice shaver 504, coolant provider 808, and one or more primary reservoirs 810.

The coolant provider 808 may comprise a tank containing a type of liquid or gaseous coolant. The coolant may be routed via separate tubing to the primary reservoirs 810, through the mounting arm 602 to the fluid dispenser 604, or to both simultaneously. The coolant tubing (not shown) may interact with tubing from the primary reservoirs 810 to cool and maintain the temperature of the flavoring. The primary reservoirs 810 may comprise tanks, bags, or other suitable container structure containing one or more flavors, which may be a liquid or may in some instances be a solid, to be dispensed from the fluid dispenser 604. The tubing may originate from these primary reservoirs 810 and run along a length of, and sometimes through an interior of, a mounting arm 602 before terminating at the fluid dispenser 604. The primary reservoirs 810 shown in FIG. 8 may contain a variety of different flavored syrups. In the figure, the primary reservoirs 810 are shown with exemplary labels “G” for grape, “L” for lemon, and “O” for orange. These labels are for purpose of example and are not intended to be limiting. In other implementations any number of flavor syrups, individually or in combination, may be contained within the primary reservoirs 810 and dispensed from the fluid dispenser 604. In some implementations instead of or in addition to flavor syrups, primary reservoirs 810 may contain water, juice, sodas, or other similar types of fluids.

The mobile edifice 502 may be a truck or van or another vehicle. While a truck is shown in the figure as an example it is not necessary for the mobile edifice 502 to be a motorized vehicle. The present disclosure may also extend to carts, wagons, hand trucks, or other such vehicles to which a fluid dispenser 604 and arm 602 may be mounted. The present disclosure may additionally extend to kiosks, stands, or other standing structures that could be transported by truck from one location to another.

The cavity 606 may comprise an opening extending into the interior of the mobile edifice 502 or may have one or more back and sidewalls defining the recess as a cavity within a sidewall of the mobile edifice 502. Within the cavity 606 may be a number of mechanisms, such as a locking mechanism 818, a deployment mechanism 814, or both. The locking mechanism 818 may comprise a button, lever, or comparable means to facilitate locking the mounting arm 602 to a particular position. A mounting arm 602 may be fully disposed within the cavity 606 in a stored position, as seen here in FIG. 8. The mounting arm 602 may also extend from the cavity 606 away from the mobile edifice 502 in a deployed position. It will be appreciated that while reference is made to “horizontal” mounting arms and “vertical” mounting arms in this disclosure, a mounting arm 602 may not move in a perfectly horizontal or vertical way relative to the mobile edifice 502. In some implementations, a mounting arm 602 may deploy at an angle relative to a sidewall of the mobile edifice 502. The locking mechanism 818 may be utilized to lock the position of the mounting arm 602 in the stored position, the deployed position, or somewhere in between in a partially deployed position.

The mounting arm 602 may additionally feature a secondary dispenser 820. The secondary dispenser 820 may comprise a faucet, spigot, nozzle, a hole, or other mechanism configured to dispense a fluid from a source within the mobile edifice 502. The source may be one of the primary reservoirs 810 or a secondary reservoir 812 independent from primary reservoirs 810. In some implementations secondary dispenser 820 may be in fluid communication with secondary reservoir 812 via tubing, labeled in FIG. 8 with a “W” to indicate water, as a non-limiting example, though any other fluid is intended to be within the scope of the present disclosure. In other implementations the secondary dispenser may dispense fluid from within the mounting arm 602, like, for example, water, from melted ice deposited into a chute within the mobile edifice 502. The secondary dispenser 820 may comprise a knob, handle, or other similar means that, when manipulated, permits the secondary dispenser 820 to dispense a fluid, depending on the source. In implementations where the secondary dispenser 820 is a hole, the fluid may continuously run or drip from secondary dispenser 820.

While FIG. 8 shows a single secondary dispenser 820 located centrally on arm 602, it will be appreciated that this disclosure is not limited to any number or positioning of secondary dispensers 820. Depending on the implementation, a mounting arm 602 may feature multiple secondary dispensers 820 located at various positions along a length of a mounting arm 602. In features utilizing multiple mounting arms 602, a user may have one or more secondary dispensers 820 on one or several of the multiple mounting arms 602 located at various positions along any of the mounting arms 602. In other implementations a user may forego a secondary dispenser 820 altogether.

It will be appreciated that while FIG. 8 shows primary reservoirs 810 as a grouping and secondary reservoir 812 as an individual container, the present disclosure is not limited to any particular number or configuration of reservoirs. Depending on the implementation a system according to the present disclosure may feature, for example, a sole primary reservoir for one purpose, a group of secondary dispensers for a secondary dispensers for another purpose, and one or more of a tertiary or onward dispenser for yet another purpose, according to the implementation and needs of a user.

The secondary dispenser 820 may allow a user to wash their hands or otherwise receive water in some implementations, while in other implementations a user may receive a different liquid they may use for another purpose. A mounting arm 602 according to the present disclosure may optionally feature such a faucet or spigot 820 and may have more than one faucet or spigot 820 depending on the implementation. FIG. 8 shows a secondary dispenser 820 mounted to a central position of mounting arm 602, but it will be appreciated that a secondary dispenser 820 may instead be located anywhere on mounting arm 602. In some implementations the secondary dispenser 820 may be located on or close to dispenser 100. In other implementations, secondary dispenser 820 may instead be located in another position on mobile edifice 502 and may reside within its own edifice recess.

The mounting arm 602 may be mounted to the mobile edifice 502 by a mount 816. The mount 816 may comprise a ball joint, a linkage, a hinge, or other similar mechanism that permits a user to mount the mounting arm 602 to the mobile edifice 502 while retaining some degree of movement depending on the mount 816 utilized. The mount 816 may retain the mounting arm 602 in a way such that the mounting arm 602 may move between a closed position or open position. In some implementations the mount 816 may be mounted to a sidewall of the edifice, while in other implementations may be mounted to another structure, such as a rack or shelf which may itself be mounted to the edifice. A rack or shelf may or may not be utilized in a situation where a user may desire to use mount 816 to mount a mounting arm 602 to a roof or underside of the mobile edifice 502. In other implementations a user may mount arm 602 via mount 816 to a roof or underside of the mobile edifice 502 directly.

A closed position may be a positioning of arm 602 whereby the mounting arm 602 is maneuvered closer to a sidewall of the mobile edifice 502 for, for example, storage purposes when the mounting arm 602 is not in use and/or while the mobile edifice 502 is travelling or otherwise in motion. In some implementations the closed position may entail a mounting arm 602 positioned within a cavity 606 as shown in FIG. 8. An open position may entail a positioning of arm 602 as shown later in FIG. 8. In such a position, a mounting arm may maneuver away from a sidewall of mobile edifice 502. A user may maneuver a mounting arm 602 freely along an axis of movement depending on the type of mount 816 used.

For example, in an implementation where a mounting arm 602 is pivotably mounted a mounting arm 602 may rotate or pivot according to an axis provided by the mount 816. In other implementations a mount 816 may comprise a ball joint in which case a mounting arm 602 may be maneuvered according to the freedom of movement allotted by a ball joint. An open position may comprise a mounting arm 602 being maneuvered fully away from mobile edifice 502 in some implementations, or in others an open position may comprise a mounting arm being maneuvered far enough away from a sidewall of mobile edifice 502 such that a user may sufficiently access a fluid dispenser 604 mounted to a mounting arm 602. Those skilled in the art will appreciate that the precise boundaries of closed position and open position may vary according to the implementation, and that any positioning of arm 602 within its freedom of movement could comprise the open position while arm 602 is in use.

The deployment mechanism 814 may be used to deploy the mounting arm 602 in some implementations, while in others the deployment mechanism 814 may be positioned outside of the cavity 606 and used to open or close the hatch door. The deployment mechanism may comprise a button or lever than when manipulated may open or close the hatch door, change the position of the mounting arm 602, or both. In some implementations a single deployment mechanism may, for example, open the hatch door and deploy the mounting arm 602 when manipulated, then store the mounting arm 602 and close the hatch door when manipulated again. In other implementations separate deployment mechanisms may exist, whereby one controls the hatch door and the other controls the mounting arm 602 position. The deployment mechanism 814 may employ a spring or a motor to operate the hatch door or the mounting arm 602. The deployment mechanism 814 may be in electrical communication with a motor in some implementations to facilitate motorized deployment between an open or closed position of a mounting arm 602. In other implementations the deployment mechanism 814 may be mechanical in nature and require a user to manually adjust a mounting arm 602 between an open and closed position. In yet other implementations the deployment mechanism 814 may comprise a lock, latch or similar mechanism separate from locking mechanism 818 that also secures a mounting arm 602 within the cavity 606. In some implementations deployment mechanism 814 may comprise both a lock, latch, or similar mechanism as well as a spring, motor, or other means for deploying one or more mounting arms 602. In some implementations deployment mechanism 814 may operate a hydraulic system which may deploy or return mounting arm 602 out to an open position or back to a closed position within the cavity 606.

FIG. 8 illustrates an example wherein the combustion devices 100 are mounted to the roof of the mobile edifice 502. However, the combustion devices 100 may additionally be mounted to a sidewall, front, rear, or other location of the mobile edifice 502. Further, while a configuration of three combustion devices 100 is shown in FIG. 8, it will be appreciated that more or less combustion devices 100 may be utilized of varying sizes. In some implementations a user may prefer one large combustion device 100, and in others a user may prefer multiple smaller ones. In yet other implementations a user may prefer a combination of some larger combustion devices 100 and some smaller combustion devices 100. In some implementations a mobile edifice 502 may additionally feature a sidewall panel that may extend from a sidewall of the mobile edifice 502 to provide a shelf onto which combustion devices 100 may be mounted.

The system 800 may include a controller (not shown in FIG. 8, see 302) located within or mounted to the mobile edifice 502. In other implementations, the controller (see 302) may be wireless and in wireless communication with the combustion devices 100 such that a user may be able to walk around or away from (within a range) the mobile edifice 502 and still activate the combustion devices 100. One or more fuel sources (not shown in FIG. 8, see 202) may be mounted to the mobile edifice 502 or located within an interior of the mobile edifice 502 with proximal fuel pipe 108 connecting to piping within the mobile edifice 502 in order to facilitate fuel flow. A user may vary activate a combustion event 318 to create a pattern or sequence of combustion events 318 with varying sizes and durations. A user may utilize the combustion events 318 to attract attention from a crowd to the mobile edifice for reasons according to a user's needs.

For example, a user may deploy any of the systems 500, 600, 700, 800 described herein at an event or location, such as a birthday party, amusement park, sports game, public park, neighborhood, or other similar locale or situation to attract the attention of bystanders. Using the controller (see 302) described herein, a user may utilize one or more combustion devices 100 to create a series of combustion events 318 to attract attention to the mobile edifice 502.

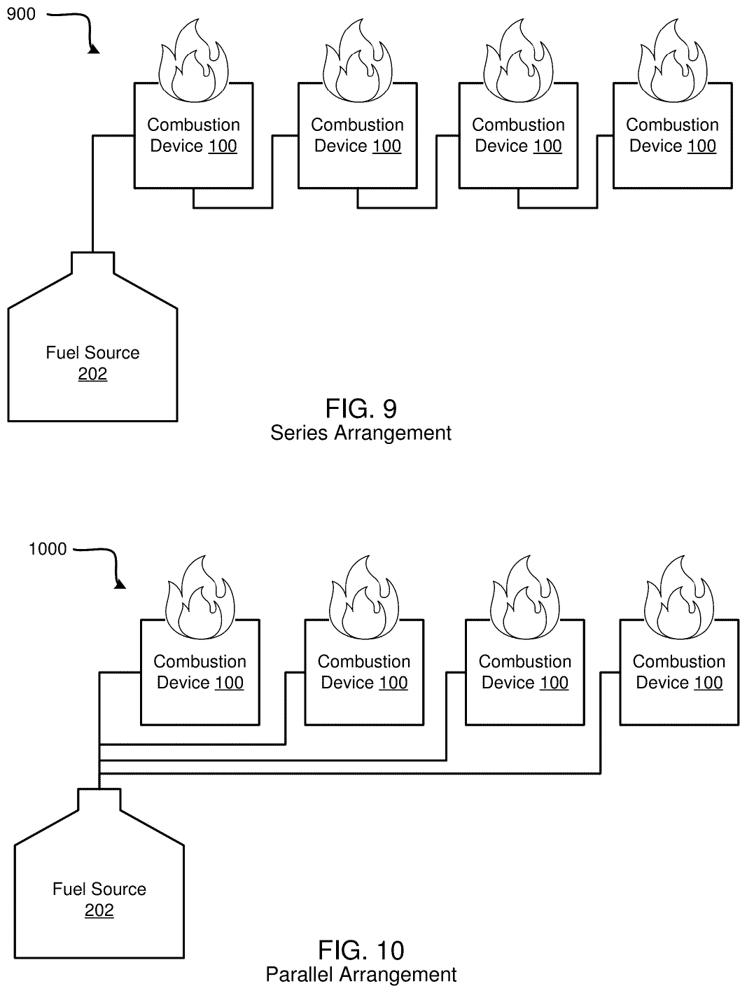

FIG. 9 is a schematic diagram of a system 900 for enabling fuel flow from a fuel source 202 to a plurality of combustion devices 100. The system 900 includes a series arrangement, such that fuel flows from the fuel source 202 to a first combustion device, and then to a second combustion device 100, and then to a third combustion device 100, and so forth.

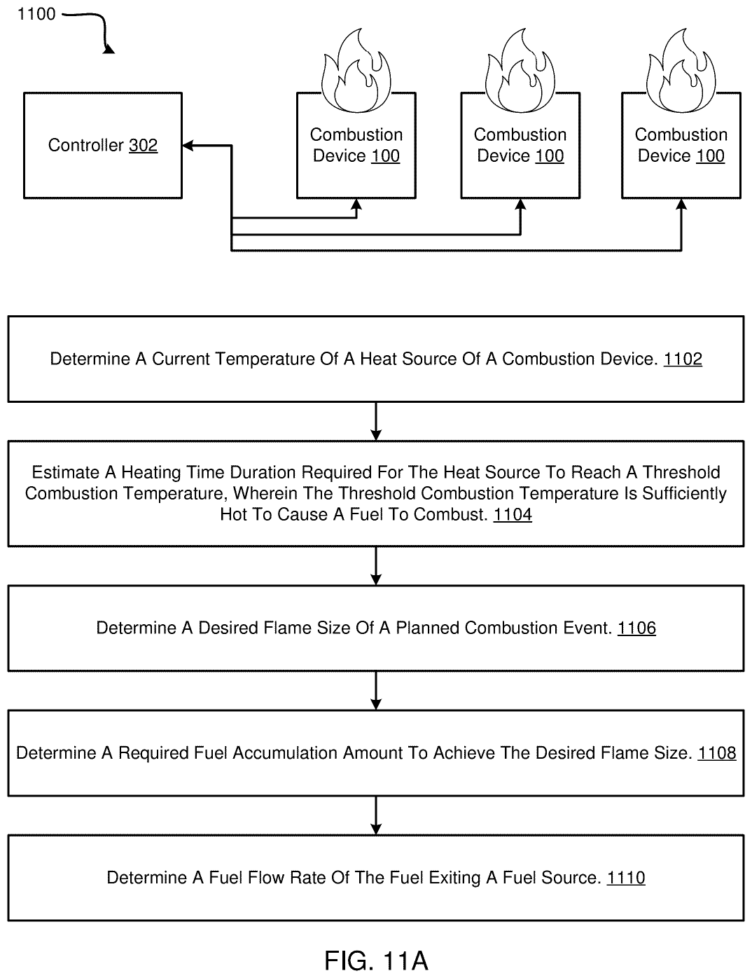

FIG. 10 is a schematic diagram of a system 1000 for enabling fuel flow from a fuel source 202 to a plurality of combustion devices 100. The system 1000 includes a parallel arrangement, such that each combustion device 100 has a dedicated pipeline to receive fuel from the fuel source 202.

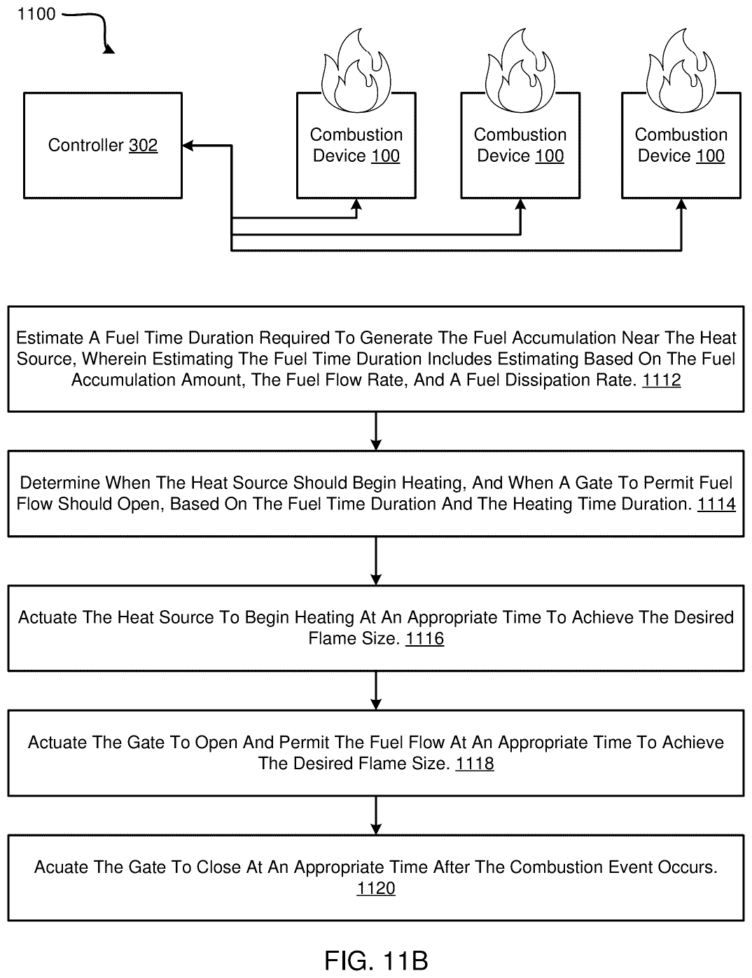

FIGS. 11A and 11B are schematic flow chart diagrams of a system and method 1100 for remotely actuating a heat source and a gate of a combustion device to trigger a combustion event having a desired flame size. The method 1100 may be performed by a controller 302 in communication with one or more combustion devices 100. The controller 302 may separately perform the method 1100 for each of the one or more combustion devices 100.

The method 1100 includes determining at 1102 a current temperature of a heat source of a combustion device. The method 1100 includes estimating at 1104 a heating time duration required for the heat source to reach a threshold combustion temperature, wherein the threshold combustion temperature is sufficiently hot to cause a fuel to combust. The method 1100 includes determining at 1106 a desired flame size of a planned combustion event. The method 1100 includes determining at 1108 a required fuel accumulation amount to achieve the desired flame size. The method 1100 includes determining at 1110 a fuel flow rate of the fuel exiting a fuel source. The method 1100 includes estimating at 1112 a fuel time duration required to generate the fuel accumulation near the heat source, wherein estimating the fuel time duration includes estimating based on the fuel accumulation amount, the fuel flow rate, and a fuel dissipation rate. The method 1100 includes determining at 1114 when the heat source should begin heating, and when the gate to permit fuel flow should open, based on the fuel time duration and the heating time duration. The method 1100 includes actuating at 1116 the heat source to begin heating at an appropriate time to achieve the desired flame size. The method 1100 includes actuating at 1118 the gate to open and permit the fuel flow at an appropriate time to achieve the desired flame size. The method 1100 includes actuating at 1120 the gate to close at an appropriate time after the combustion event occurs.

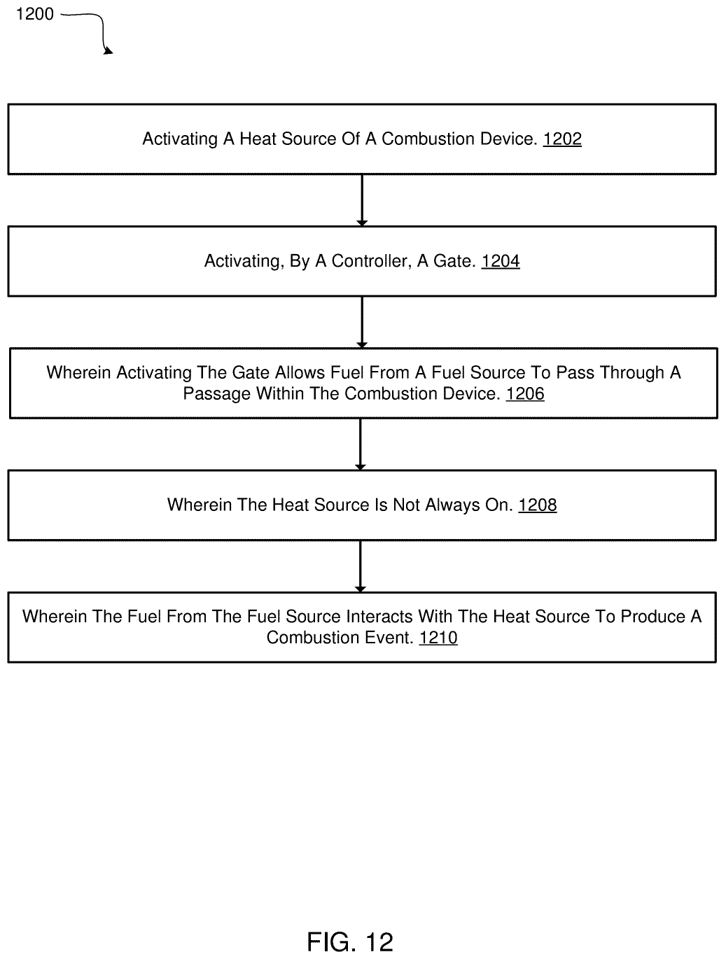

FIG. 12 is a schematic flow chart diagram of a method 1200 for triggering a combustion event. The method 1200 includes activating at 1202 a heat source of a combustion device. The method 1200 includes activating at 1204, by a controller, a gate. The method 1200 includes wherein activating the gate allows fuel from a fuel source to pass through a passage within the combustion device (see 1206). The method 1200 includes wherein the heat source is not always on (see 1208). The method 1200 includes wherein the fuel from the fuel source interacts with the heat source to produce a combustion event (see 1210).

The following examples pertain to features of further embodiments of the disclosure.

### EXAMPLES

Example 1 is a system for producing a timed combustion event comprising a combustion device. The combustion device comprises a heat source and a plunger mechanism. The system may additionally feature a fuel source and a controller. The controller controls a combustion event whereby the plunger mechanism is activated to opens a passage within the combustion device such that gas from the fuel source interacts with the heat source.

Example 2 is a system according to Example 1, wherein the controller is configured to manually activate the combustion event.

Example 3 is a system according to Examples 1 or 2, wherein the controller is configured to activate the combustion event according to a programmable time interval.

Example 4 is a system according to any of Examples 1-3, further comprising a plurality of combustion devices and wherein each combustion device is configured with a different timing to produce a differently timed combustion event.

Example 5 is a system according to any of Examples 1-4, wherein the controller activates each combustion device in sequence.

Example 6 is a system according to any of Examples 1-5, further comprising a mobile edifice, and wherein the combustion device is mounted to the mobile edifice.

Example 7 is a system according to any of Examples 1-6, wherein the heat source of the combustion device comprises an igniter or a sparker.

Example 8 is a system according to any of Examples 1-7, wherein the programmable time interval ranges from about 10 minutes to about 45 minutes.

Example 9 is a system according to any of Examples 1-8, wherein the plunger mechanism opens the passage for a time period of about 0.001 seconds to about 0.4 seconds.

Example 10 is a system according to any of Examples 1-9, wherein the heat source is activated for a period of time in advance of the combustion event.

Example 11 is a method for creating a combustion event, the steps comprising activating a heat source of a combustion device and activating, by a controller, a plunger mechanism. The method comprises wherein activating the plunger mechanism allows gas from a fuel source to pass through a passage within the combustion device. The method comprises wherein the heat source is not always on, and wherein the gas from the fuel source interacts with the heat source to produce a combustion event.

Example 12 is a method according to Example 11, wherein the controller is configured to manually activate the combustion event.

Example 13 is a method according to Examples 11 or 12, wherein the controller is configured to activate the combustion event according to a programmable time interval.

Example 14 is a method according to any of Examples 11-13, further comprising a plurality of combustion devices and wherein each combustion device is configured with a different timing to produce a different timed event.

Example 15 is a method according to any of Examples 11-14, wherein the controller activates each combustion device in a sequence.

Example 16 is a method according to any of Examples 11-15, further comprising a mobile edifice, and wherein the combustion device is mounted to the mobile edifice.

Example 17 is a method according to any of Examples 11-16, wherein the heat source of the combustion device comprises an igniter or a sparker.

Example 18 is a method according to any of Examples 11-17, wherein the programmable time interval ranges from about 10 minutes to about 45 minutes.

Example 19 is a method according to any of Examples 11-18, wherein the plunger mechanism opens the passage for a time period of about 0.001 seconds to about 0.4 seconds.

Example 20 is a method according to any of Examples 11-19, wherein the heat source is activated for a period of time in advance of the combustion event.

Example 21 is a system according to any of Examples 1-10 further comprising a mobile edifice.

Example 22 is a system according to any of Examples 1-10 or 21, wherein the combustion device is mounted to the mobile edifice.

Example 23 is a system according to any of Examples 1-10 or 21-22, wherein the combustion device is not mounted to the mobile edifice and wherein the combustion device is remotely operated from within the mobile edifice.

Example 24 is a system. The system includes a mobile edifice, a controller, a fuel source comprising a fuel, and a combustion device mounted to the mobile edifice. The combustion device includes a heat source in electronic communication with the controller and a gate in electronic communication with the controller, wherein the gate opens to permit fuel to flow from the fuel source to toward the heat source. The controller actuates the heat source and the gate to trigger a combustion event.

Example 25 is a system as in Example 24, wherein the mobile edifice is a vehicle, and wherein the combustion device is mounted an exterior surface of the mobile edifice.

Example 26 is a system as in any of Examples 24-25, further comprising a heat source cable providing direct electrical connection between the fuel source and the controller; wherein the controller transmits power to the heat source by way of the heat source cable; and wherein the heat source cable enables bidirectional data communication between the controller and the heat source.

Example 27 is a system as in any of Examples 24-26, further comprising a gate cable providing direct electrical connection between the gate and the controller.

Example 28 is a system as in any of Examples 24-27, further comprising a proximal fuel pipe and a distal fuel pipe, wherein the distal fuel pipe is located distal to the fuel source relative to the proximal fuel pipe, and wherein the gate is disposed in between the proximal fuel pipe and the distal fuel pipe.

Example 29 is a system as in any of Examples 24-28, wherein the controller tracks a current temperature of the heat source.

Example 30 is a system as in any of Examples 24-29, wherein the controller estimates a heating duration required for the heat source to reach a threshold combustion temperature wherein the fuel will combust when disposed near the heat source.

Example 31 is a system as in any of Examples 24-30, wherein the controller determines an open gate duration required for a sufficient amount of fuel to pass through the gate and accumulate near the heat source to trigger the combustion event comprising a desired flame size; and wherein the controller determines when to cause the heat source to begin heating, and when to open the gate to permit the fuel to flow toward the heat source, based at least in part on the heating duration, the open gate duration, and the desired flame size.

Example 32 is a system as in any of Examples 24-31, wherein the controller optimizes timing for opening the gate and actuating the heat source based on a desired flame size of the combustion event.

Example 33 is a system as in any of Examples 24-32, wherein, in response to receiving an indication to trigger a larger combustion event, the controller opens the gate prior to the heat source reaching a threshold combustion temperature to enable a sufficiently large fuel accumulation to accumulate near the heat source to trigger the larger combustion event.

Example 34 is a system as in any of Examples 24-33, wherein the system comprises a plurality of combustion devices each mounted to the mobile edifice.

Example 35 is a system as in any of Examples 24-34, wherein the plurality of combustion devices are arranged such that the fuel from the fuel source flows to the combustion devices in a series arrangement.

Example 36 is a system as in any of Examples 24-35, wherein the plurality of combustion devices are arranged such that the fuel from the fuel source flows to the combustion devices in a parallel arrangement.

Example 37 is a system as in any of Examples 24-36, wherein the controller is in electronic communication with the heat source and the gate of each of the plurality of combustion devices.

Example 38 is a system as in any of Examples 24-37, wherein the mobile edifice is configured for preparing and/or serving an edible product, and wherein the system further comprises a device for preparing and/or serving the edible product.

Example 39 is a system as in any of Examples 24-38, further comprising one or more of a grill, stove, cooktop, refrigerator, or ice shaver mounted to and/or disposed within the mobile edifice.

Example 40 is a system as in any of Examples 24-39, further comprising: an ice shaver mounted to and/or disposed within the mobile edifice; and a fluid dispenser mounted to the mobile edifice, wherein the fluid dispenser comprises a means for a user to dispense a fluid topping on to a shaved ice confection.

Example 41 is a system as in any of Examples 24-40, wherein the controller communicates with one or more of the heat source or the gate by way of a wireless communication protocol.

Example 42 is a system as in any of Examples 24-41, wherein the controller communicates with one or more of the heat source or the gate by way of a wired connection.

Example 43 is a system as in any of Examples 24-42, wherein the system comprises a plurality of combustion devices mounted to the mobile edifice; wherein the controller is in electronic communication with the heat source and the gate of each of the plurality of combustion devices; wherein the controller actuates components of the plurality of combustion devices in sequence to generate a plurality of combustion events; and wherein two or more of the plurality of combustion events comprises a different size flame and/or a different flame duration.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A system comprising:
a mobile edifice;
a controller;
a fuel source comprising a fuel; and
a combustion device mounted to the mobile edifice, wherein the combustion device comprises:
a heat source in electronic communication with the controller; and
a gate in electronic communication with the controller, wherein the gate opens to permit fuel to flow from the fuel source to toward the heat source;
wherein the controller actuates the heat source and the gate to trigger a combustion event.

2. The system of claim 1, wherein the mobile edifice is a vehicle, and wherein the combustion device is mounted an exterior surface of the mobile edifice.

3. The system of claim 1, further comprising a heat source cable providing direct electrical connection between the fuel source and the controller;
wherein the controller transmits power to the heat source by way of the heat source cable; and
wherein the heat source cable enables bidirectional data communication between the controller and the heat source.

4. The system of claim 1, further comprising a gate cable providing direct electrical connection between the gate and the controller.

5. The system of claim 1, further comprising a proximal fuel pipe and a distal fuel pipe, wherein the distal fuel pipe is located distal to the fuel source relative to the proximal fuel pipe, and wherein the gate is disposed in between the proximal fuel pipe and the distal fuel pipe.

6. The system of claim 1, wherein the controller tracks a current temperature of the heat source.

7. The system of claim 1, wherein the controller estimates a heating duration required for the heat source to reach a threshold combustion temperature wherein the fuel will combust when disposed near the heat source.

8. The system of claim 7, wherein the controller determines an open gate duration required for a sufficient amount of fuel to pass through the gate and accumulate near the heat source to trigger the combustion event comprising a desired flame size; and
wherein the controller determines when to cause the heat source to begin heating, and when to open the gate to permit the fuel to flow toward the heat source, based at least in part on the heating duration, the open gate duration, and the desired flame size.

9. The system of claim 1, wherein the controller optimizes timing for opening the gate and actuating the heat source based on a desired flame size of the combustion event.

10. The system of claim 9, wherein, in response to receiving an indication to trigger a larger combustion event, the controller opens the gate prior to the heat source reaching a threshold combustion temperature to enable a sufficiently large fuel accumulation to accumulate near the heat source to trigger the larger combustion event.

11. The system of claim 1, wherein the system comprises a plurality of combustion devices each mounted to the mobile edifice.

12. The system of claim 11, wherein the plurality of combustion devices are arranged such that the fuel from the fuel source flows to the combustion devices in a series arrangement.

13. The system of claim 11, wherein the plurality of combustion devices are arranged such that the fuel from the fuel source flows to the combustion devices in a parallel arrangement.

14. The system of claim 11, wherein the controller is in electronic communication with the heat source and the gate of each of the plurality of combustion devices.

15. The system of claim 1, wherein the mobile edifice is configured for preparing and/or serving an edible product, and wherein the system further comprises a device for preparing and/or serving the edible product.

16. The system of claim 1, further comprising one or more of a grill, stove, cooktop, refrigerator, or ice shaver mounted to and/or disposed within the mobile edifice.

17. The system of claim 1, further comprising:
an ice shaver mounted to and/or disposed within the mobile edifice; and
a fluid dispenser mounted to the mobile edifice, wherein the fluid dispenser comprises a means for a user to dispense a fluid topping on to a shaved ice confection.

18. The system of claim 1, wherein the controller communicates with one or more of the heat source or the gate by way of a wireless communication protocol.

19. The system of claim 1, wherein the controller communicates with one or more of the heat source or the gate by way of a wired connection.

20. The system of claim 1, wherein the system comprises a plurality of combustion devices mounted to the mobile edifice;
wherein the controller is in electronic communication with the heat source and the gate of each of the plurality of combustion devices;
wherein the controller actuates components of the plurality of combustion devices in sequence to generate a plurality of combustion events; and
wherein two or more of the plurality of combustion events comprises a different size flame and/or a different flame duration.
